(19) United States
(12) Patent Application Publication
(10) Pub. No.: US 2025/0044414 A1
(43) Pub. Date: Feb. 6, 2025

(54) A METHOD FOR GENERATING A DEPTH MAP

(71) Applicant: ams-OSRAM Asia Pacific Pte. Ltd., Singapore (SG)

(72) Inventors: Loïc PERRUCHOUD, Rechy (CH); Jérôme MAYE, Martigny (CH)

(21) Appl. No.: 18/719,267

(22) PCT Filed: Dec. 16, 2022
(86) PCT No.: PCT/SG2022/050916

§ 371 Date: Jun. 13, 2024

(30) Foreign Application Priority Data
Dec. 17, 2021 (GB) 2118457.7

(51) Int. Cl. G01S 7/48; G01S 7/497; G01S 17/42; G01S 17/89

(52) U.S. Cl. CPC G01S 7/4808; G01S 7/497; G01S 17/42; G01S 17/89

(57) ABSTRACT

A method for generating a depth map for a field of view includes illuminating the field of view with a plurality of discrete radiation beams and detecting a reflected portion of at least some of the plurality of discrete radiation beams. The method further includes determining range information for an object within the field of view from which each reflected portion was reflected based on time of flight. The method further includes identifying a corresponding one of the plurality of discrete radiation beams from which each reflected portion originated. The method further includes generating a depth map including a plurality of points, each point having: a depth value corresponding to determined range information for a detected reflected portion of a discrete radiation beam; and a position within the depth map corresponding to a position of the identified corresponding one of the plurality of discrete radiation beams.

### RELATED APPLICATIONS

This application is a US National Stage Application of International Application PCT/SG2022/050916, filed on 16 Dec. 2022, and claims priority under 35 U.S.C. § 119 (a) and 35 U.S.C. § 365 (b) from United Kingdom Patent Application GB 2118457.7, filed on 17 Dec. 2021, the contents of which are incorporated herein by reference in their entirety.

### TECHNICAL FIELD

This disclosure relates to a method for generating a depth map for a field of view using time of flight information. The disclosure also relates to an associated apparatus for performing the method. The method may, for example, find application in augmented reality, 3D sensing or 3D modeling. The apparatus may, for example, find application in smart phones, smart glasses, virtual reality headsets and robotic systems.

### BACKGROUND

The present disclosure relates to a method for generating a depth map for a field of view using time of flight information.

Systems for generating depth map for a field of view may comprise a radiation source (for example a laser) that is operable to emit radiation so as to illuminate a field of view and a sensor operable to measure a portion of the emitted radiation that is reflected from objects disposed in the field of view. The system is operable to determine depth information of objects in the field of view from the radiation measured by the sensor.

The depth of view system may further comprise focusing optics, which are arranged to form an image of the field of view on the sensor. The sensor may comprise a plurality of separate sensing elements, each sensing element receiving radiation from a different part of the field of view (for example an element of solid angle). Each sensing element may correspond to a pixel of the system and the terms sensing element and pixel may be used interchangeably in the following.

Systems for generating depth map for a field of view may have many applications. For example, these systems may find application in augmented reality, 3D sensing or 3D modeling. These systems may be implemented in any suitable hardware such as, for example, smart phones, smart glasses, virtual reality headsets and robotic systems.

A first type of known system uses time of flight information to determine depth information of objects in the field of view. These systems convert the time taken between emission of the radiation and the receipt of the reflected radiation into a depth using the speed of light. If reflected radiation is received by a sensing element of the sensor then it may be determined that an object is disposed in a corresponding part of the field of view (for example a given element of solid angle). A distance or depth can be determined for each pixel and, in this way, a depth map of the field of view can be determined. Time of flight systems typically illuminate the whole of the field of view with radiation. Time of flight systems can be either direct or indirect. A direct time of flight system directly measures the time between emission of the radiation and the receipt of the reflected radiation. An indirect time of flight system uses (time) modulated radiation to illuminate the field of view and measures a phase of the modulation at the sensor. The measured phase is converted into the time between emission of the radiation and the receipt of the reflected radiation using the frequency of modulation. The measured phase corresponds to multiple candidate times of flight and therefore indirect time of flight systems also have some system for selecting one specific time of flight.

A second type of known system uses a structured light source to emit a spatial light pattern into the field of view. A reflection of this spatial light pattern from objects in the field of view is detected by the sensor. Any distortion of the measured light pattern relative to the emitted light pattern is attributed to reflection from objects at varying depths and this distortion is converted onto a depth map. That is, in a structured light source system for generating a depth map for a field of view, positions of various features in the measured light pattern are converted into depth values. Such systems may use triangulation.

It is known that time of flight systems and structured light systems each have different advantages and disadvantages and may have complementary sources of errors. Therefore, in some known systems, both time of flight and structured light measurements are used in combination to determine depth information.

It is an aim of the present disclosure to provide a method for generating a depth map for a field of view (and an associated apparatus) which addresses one or more of problems associated with prior art arrangements, whether identified above or otherwise.

### SUMMARY

In general, this disclosure proposes to illuminate a field of view with a plurality of discrete radiation beams to produce a sparse depth map comprising a plurality of discrete points wherein a position within said depth map corresponds to a position or direction of a corresponding one of the plurality of discrete radiation beams. That is, a plurality of discrete radiation beams is projected onto the field of view and a plurality of discrete spots are measured using a sensor in a sensor plane. The depth for each discrete spot on the sensor is determined based on time of flight information. The plurality of discrete spots that are measured are used to produce the sparse (or discrete) depth map wherein a depth for each discrete spot is determined based time of flight information. However, rather than using a position for each discrete spot based on a position of that spot on the sensor, as typically done in time of flight based depth systems, a position of the corresponding discrete radiation beams that was projected onto the field of view is used. That is, the depth for each point in the sparse or discrete depth map is determined using the sensor (for example in a sensor plane) whereas the position of each point is based on the projector (for example in a projector plane). Using such a plurality of discrete radiation beams reduces the amount of energy used by the system while keeping high quality and still covering a large depth range. The sparse or discrete depth map may be combined or fused with another image of the field of view (for example a photograph) to effectively interpolate between the discrete points within the field of view that are sampled using the plurality of discrete radiation beams so as to produce a dense depth map. Using a position for each point of the discrete depth map of the corresponding discrete radiation beam that was projected onto the field of view significantly reduces the errors in this interpolation.

According to a first aspect of the present disclosure there is provided a method for generating a depth map for a field of view, the method comprising: illuminating the field of view with a plurality of discrete radiation beams; detecting a reflected portion of at least some of the plurality of discrete radiation beams; determining range information for an object within the field of view from which each reflected portion was reflected based on time of flight; identifying a corresponding one of the plurality of discrete radiation beams from which each reflected portion originated; and generating a depth map comprising a plurality of points, each point having: a depth value corresponding to a determined range information for a detected reflected portion of a discrete radiation beam; and a position within the depth map corresponding to a position of the identified corresponding one of the plurality of discrete radiation beams.

The method according to the first aspect can be advantageous over known methods, as now discussed.

A first type of prior art method involves illumination of the field of view with radiation and then uses time of flight information to determine depth information of objects in the field of view. This prior art method outputs a depth map with each pixel of the depth map being assigned a position on a sensor of a detected reflected portion of the illumination radiation. In contrast to the method according to the first aspect, such known systems do not assign a position within the depth map for each pixel that corresponds to a position of an identified corresponding discrete radiation beams of the illumination radiation.

A second type of prior art method involves the use of a structured light source to emit a spatial light pattern (for example a plurality of stripes) into the field of view. Any distortion of a measured light pattern on a sensor relative to the emitted light pattern is attributed to reflection from objects at varying depths and this distortion is converted onto a depth map. Such systems use triangulation to determine depth information. In contrast to the method according to the first aspect, such systems do not use time of flight information.

A third type of prior art method involves the use of both time of flight and structured light measurements used in combination to determine depth information. This is in contrast to the method according to the first aspect, which uses time of flight information alone to determine depth information.

Compared to such known systems, the present method according to the first aspect disclosed can be advantageous because it provides a system that benefits from the advantages of time of flight systems (such as high quality measurements and a large depth range) whilst reducing the amount of energy used by the system. The positions of the dots on the time-of-flight sensor (which may, for example, comprise a SPAD array) vary with the distance due to the parallax effect. The inventors have realised that the accuracy of the measurement of this position using the sensor is, in general, limited by the resolution of the sensor. As a result, there is an error in the measured position of each dot on the sensor. If this measured position is used to produce a sparse or discrete depth map which is subsequently combined or fused with another image of the field of view (for example a photograph) to effectively interpolate between the discrete points within the field of view that are sampled using the plurality of discrete radiation beams then these errors can significantly affect the combined image. For example, straight edges of an object can be curved or wavy in the combined image, which is undesirable. By producing a sparse or discrete depth map using position information for each dot from the projector rather than the sensor, such errors can be significantly reduced.

Whilst it has previously been known to combine time-of-flight with structured light to improve the accuracy of range measurements, the method according to the first aspect uses time of flight information for range and depth measurement and information from the projected radiation light to improve an x,y positioning of this measurement on the sensor.

Ranges information determined by a system using the method according to the first aspect is combined with a structured light model encoding the dot positions as a function of the distance to infer an accurate position for each distance measurement within the depth map. The structured light encoding may be estimated from calibration. As a result, the method according to the first aspect allows to estimate the dot position with a subpixel accuracy. Said differently, it enables to reach a resolution superior to the physical resolution of the sensor. For example, the method according to the first aspect may allow to estimate the dot position with an accuracy of the order of 0.1 pixels of the sensor. This allows to provide distance measurements with a very precise position on the sensor and may significantly improve the quality of the final depth map. Typically, the precise position of the distance measurements might have a major impact when estimating the depth close to the edges of objects.

The method may comprise: for each of the plurality of discrete radiation beams: monitoring a region of a sensor that can receive reflected radiation from that discrete radiation beam.

The region of the sensor may comprise a plurality of sensing elements or pixels of the sensor. For example, the region of the sensor may comprise a square array of sensing elements or pixels of the sensor. If radiation is received by the monitored region of the sensor range information for an object within the field of view from which that reflected portion was reflected is determined based on time of flight. Furthermore, the reflected portion may be associated with, or said to correspond to, the discrete radiation beam from which reflected radiation can be received by that region of the sensor.

If radiation is received in the monitored region of the sensor for a given discrete radiation beam then that given discrete radiation beam may be identified as the corresponding one of the plurality of discrete radiation beams from which a reflected portion originated.

It will be appreciated that, due to the parallax effect the expected position of each dot on the time-of-flight sensor corresponding to a discrete radiation beam will move over time.

The method may comprise: for a plurality of time intervals from emission of the plurality of discrete radiation beams: for each of the plurality of discrete radiation beams: monitoring a region of a sensor that the reflected portion of that discrete radiation beam can be received by.

For example, each of the plurality of time intervals may correspond to a range interval. For example, the method may detect radiation from any objects with a range of 0 to 1 m in a first time interval, then detect radiation from any objects with a range of 1 to 2 m in a second time interval and so on. A region on the sensor that is monitored for a given discrete radiation beam may be different for each different time (or equivalently range) interval.

Determining range information for an object within the field of view from which a reflected portion was reflected based on time of flight may comprise measuring a time interval from the projection of a discrete radiation beam to the detection of a reflected portion thereof.

This may be referred to as direct time of flight measurement. The range information may be determined from the time interval and a speed of the radiation (e.g. the speed of light). Alternatively, in some other embodiments, the discrete radiation beams may be modulated and determining a range information for an object within the field of view from which a reflected portion was reflected based on time of flight may comprise measuring a phase of such modulation. A range may be determined from the phase, a speed of the radiation (e.g. the speed of light) and the frequency of the modulation. This may be referred to as indirect time of flight measurement.

The position of the identified corresponding one of the plurality of discrete radiation beams may correspond to an angle at which that corresponding discrete radiation beam is emitted into the field of view.

This position may be represented in a projector plane. The projector plane may be a focal plane of projector optics arranged to direct the plurality of discrete radiation beams into the field of view. Note that although each point of the depth map has a position within the depth map corresponding to a position of the identified corresponding one of the plurality of discrete radiation beams, this position may be projected onto any other plane. For example, this position may be projected onto an image plane of a sensor or detector used to detect the reflected portions of the plurality of discrete radiation beams. It will be appreciated that this projection is merely a geometric transformation from the projector image plane to another plane.

The position within the depth map corresponding to a position of each discrete radiation beam may be stored in memory.

The position within the depth map corresponding to a position of the identified corresponding discrete radiation beam may be determined from calibration data.

Such calibration data may be determined once, for example, following manufacture of an apparatus for carrying out the method according to the first aspect. Alternatively, calibration data may be determined periodically.

The method may further comprise determining calibration data from which the position within the depth map corresponding to a position of the each of the plurality of discrete radiation beams may be determined. Determining calibration data may comprise: providing a flat reference surface in the field of view; illuminating the field of view with the plurality of discrete radiation beams; and detecting a position of reflected portion of each of the plurality of discrete radiation beams.

The method may further comprise combining the depth map comprising a plurality of points with another image to form a dense depth map.

This combination may comprise any known techniques, to produce a dense depth map. Such known techniques may take as input a sparse depth map and another image. The sparse depth map and other image may be fused using a machine learning model. The machine learning model may be implemented using a neural network. Such techniques may be referred to as RGB-depth map fusion or depth map densification.

According to a second aspect of the present disclosure, there is provided an apparatus for generating a depth map for a field of view, the apparatus operable to implement the method according to the first aspect of the present disclosure.

The apparatus according to the second aspect may have any of the features of the method according to the first aspect.

The apparatus may comprise: a radiation source that is operable to emit a plurality of discrete radiation beams; a sensor operable to receive and detect a reflected portion of at least some of the plurality of discrete radiation beams; and a controller operable to control the radiation source and the sensor and further operable to implement any steps of the method according to the first aspect of the present disclosure.

The controller may comprise any suitable processor. The controller may be operable to determine range information for an object within the field of view from which each reflected portion was reflected based on time of flight. The controller may be operable to identify a corresponding one of the plurality of discrete radiation beams from which each reflected portion originated. The controller may be operable to generate a depth map comprising a plurality of points, each point having: a depth value corresponding to determined range information for a detected reflected portion of a discrete radiation beam; and a position within the depth map corresponding to a position of the identified corresponding one of the plurality of discrete radiation beams.

The apparatus may further comprise focusing optics arranged to form an image of a field of view in a plane of the sensor.

The sensor may comprise an array of sensing elements.

Each sensing element in the two dimensional array of sensing elements may comprise a single-photon avalanche diode.

### BRIEF DESCRIPTION OF THE DRAWINGS

Some embodiments of the disclosure will now be described by way of example only and with reference to the accompanying drawings, in which:

FIG. 1 is a schematic illustration of an apparatus 100 for generating a depth map of a field of view in accordance with the present disclosure;

FIG. 2 is a schematic illustration of a method 200 for generating a depth map for a field of view;

FIG. 3A is a schematic representation of the trajectory of a single discrete radiation beam from the radiation source of the apparatus shown in FIG. 1 to the field of view and the trajectory a reflected portion of that discrete radiation beam;

FIG. 3B is a schematic representation of the trajectory of a single discrete radiation beam from the radiation source of the apparatus shown in FIG. 1 to the field of view and four possible different trajectories of a reflected portion of that discrete radiation beam, each corresponding to reflection from a different depth in the field of view;

FIG. 4 is a schematic illustration of a method for determining calibration data that may form part of the method shown schematically in FIG. 2;

FIG. 5A shows a depth map for a field of view comprising a plurality of points and formed using the method shown in FIG. 2;

FIG. 5B shows another image of the field of view the depth map for which is shown in FIG. 5A;

FIG. 5C shows the sparse depth map shown in FIG. 5A overlaid with the other image shown in FIG. 5B; and FIG. 5D shows a dense depth map produced from the combination of the sparse depth map shown in FIG. 5A with the other image of the field of view shown in FIG. 5B.

### DETAILED DESCRIPTION

Generally speaking, the disclosure provides a method, and associated apparatus, for generating a depth map of a field of view. The method involves the illumination a field of view with a plurality of discrete radiation beams to produce a sparse depth map comprising a plurality of discrete points wherein a position within said depth map corresponds to a position or direction of a corresponding one of the plurality of discrete radiation beams. The sparse or discrete depth map may be combined, or fused, with another image of the field of view (for example a colour photograph) to effectively interpolate between the discrete points within the field of view that are sampled using the plurality of discrete radiation beams so as to produce a dense or continuous depth map.

Some examples of the solution are given in the accompanying figures.

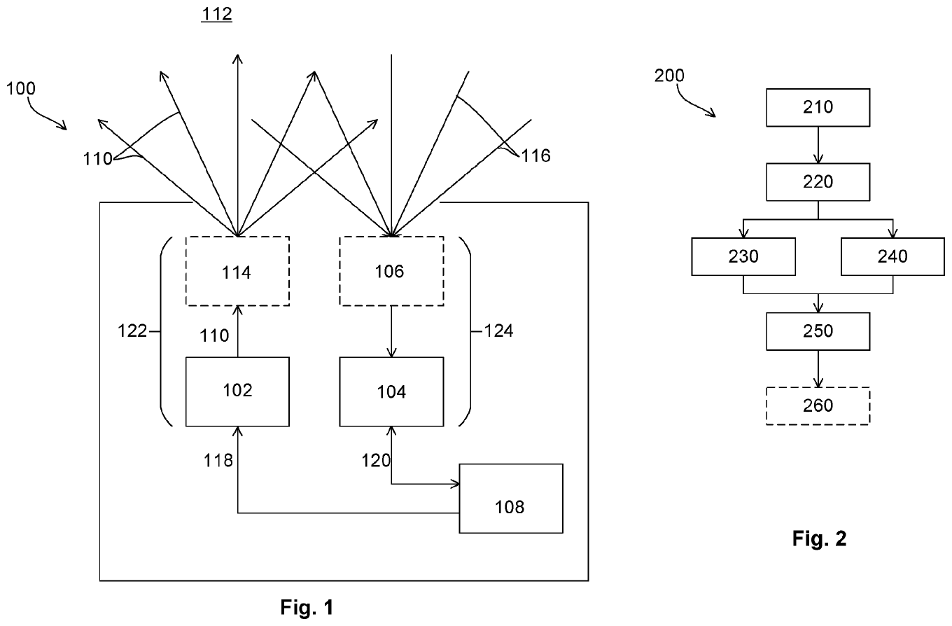

FIG. 1 is a schematic illustration of an apparatus 100 for generating a depth map of a field of view in accordance with the present disclosure. The apparatus 100 comprises a radiation source 102, a sensor 104 and a controller 108.

The radiation source 102 is operable to emit radiation so as to illuminate a field of view 112. In particular, the radiation source 102 is operable to emit a plurality of discrete radiation beams 110 so as to illuminate the field of view 112 with the plurality of discrete radiation beams 110. The radiation source 102 may comprise a plurality of radiation emitting elements such as, for example, laser diodes. Each radiation emitting element may be operable to output one of the discrete radiation beams 110. Additionally or alternatively, the radiation source 102 may comprise a single radiation emitting element and splitting optics that together are operable to output a plurality of the discrete radiation beams 110.

Optionally, the apparatus 100 may further comprise focusing optics 106. The focusing optics 106 may be arranged to form an image of the field of view 112 in a plane of the sensor 104. The sensor 104 is operable to receive and detect a reflected portion 116 of at least some of the plurality of discrete radiation beams 110. Such reflected portions 116 may, for example, be reflected from objects disposed in the field of view 112. The sensor 104 comprises a two dimensional array of sensing elements. The sensor 104 may comprise various radiation sensitive technologies, including silicon photomultipliers (SiPM), singlephoton avalanche diodes (SPAD), complementary metal-oxide-semiconductors (CMOS) or charged-coupled devices (CCD). The sensor 104 may have any resolution, and may comprise any number of rows and columns of sensing elements as desired. In some embodiments, the sensor 104 may comprise 320×240 sensing elements, which may be referred to as QVGA (quarter video graphics array) resolution. In some embodiments, the sensor 104 may comprise 160×120 sensing elements, which may be referred to as QQVGA (quarter QVGA) or Q2VGA resolution.

Since the focusing optics 106 form an image of the field of view 112 in a plane of the sensor 104, the two dimensional array of sensing elements divides the field of view 112 into a plurality of pixels, each pixel corresponding to a different solid angle element. The focusing optics 106 is arranged to focus radiation 116 received from the solid angle element of each pixel to a different sensing element of the sensor. In the following, the term pixel may be used interchangeably to mean either a sensing element of the sensor 104 or the corresponding solid angle element of the field of view that is focused onto that sensing element.

The controller 108 is operable to control operation of the radiation source 102 and the sensor 104, as explained further below. For example, the controller 108 is operable to send a control signal 118 to the radiation source 102 to control emission of radiation 110 therefrom. Similarly, the controller 108 is operable to exchange signals 120 with the sensor 104. The signals 120 may include control signals to the sensor 104 to control activation of sensing elements within the two dimensional array of sensing elements; and return signals containing intensity and/or timing information determined by the sensor 104.

Optionally, the apparatus 100 may comprise projection optics 114 operable to direct radiation 100 from the radiation source 102 to the field of view 112. The projection optics 114 may comprise dispersive optics. The radiation source 102 and, if present, the projection optics 114 may be considered to be a projector 122. The sensor 104 and, if present, the focusing optics 106 may be considered to be a camera 124.

The controller 108 may comprise any suitable processor. The controller 108 may be operable to determine range information for an object within the field of view 112 from which each reflected portion 116 was reflected based on time of flight. The controller 108 may be operable to identify a corresponding one of the plurality of discrete radiation beams 110 from which each reflected portion 116 originated. The controller 108 may be operable to generate a depth map comprising a plurality of points, each point having: a depth value corresponding to determined range information for a detected reflected portion 116 of a discrete radiation beam 110; and a position within the depth map corresponding to a position of the identified corresponding one of the plurality of discrete radiation beams 110.

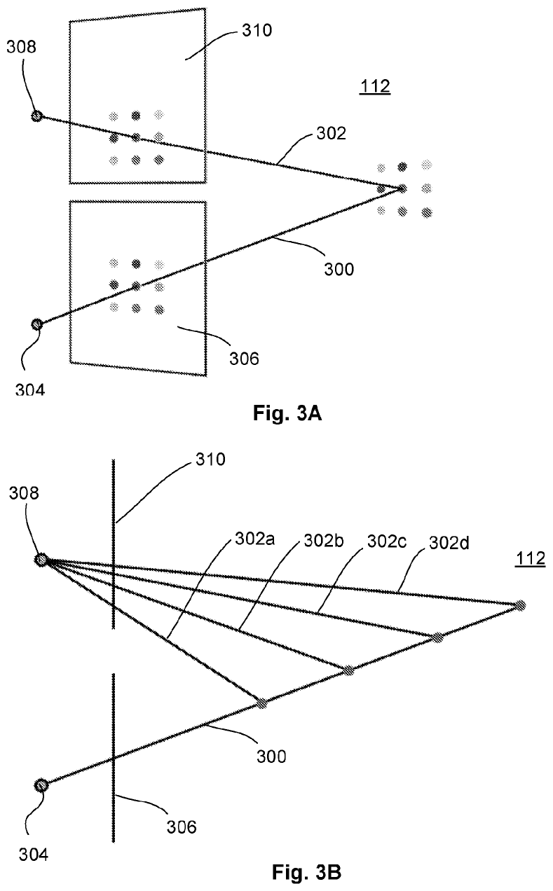

Some embodiments of the present disclosure relate to new methods for generating a depth map for a field of view 112, as discussed further below (with reference to FIGS. 2 to 5D). The controller 108 is operable to control operation of the radiation source 102 and the sensor 104 so as to implement these new methods (described below).

FIG. 2 is a schematic illustration of a method 200 for generating a depth map for a field of view. The method 200 comprises a step 210 of illuminating the field of view 112 with a plurality of discrete radiation beams 110. The method 200 further comprises a step 220 of detecting a reflected portion 116 of at least some of the plurality of discrete radiation beams 110.

The method 200 comprises a step 230 of determining range information for an object within the field of view 112 from which each reflected portion 116 was reflected based on time of flight information.

The method 200 comprises a step 240 of identifying a corresponding one of the plurality of discrete radiation beams 110 from which each reflected portion 116 originated.

It will be appreciated that steps 230 and 240 may be performed in any order or in parallel, as schematically depicted in FIG. 2. The method 200 comprises a step 250 of generating a depth map comprising a plurality of points, each point having: a depth value corresponding to determined range information for a detected reflected portion 116 of a discrete radiation beam; and a position within the depth map corresponding to a position of the identified corresponding one of the plurality of discrete radiation beams 110.

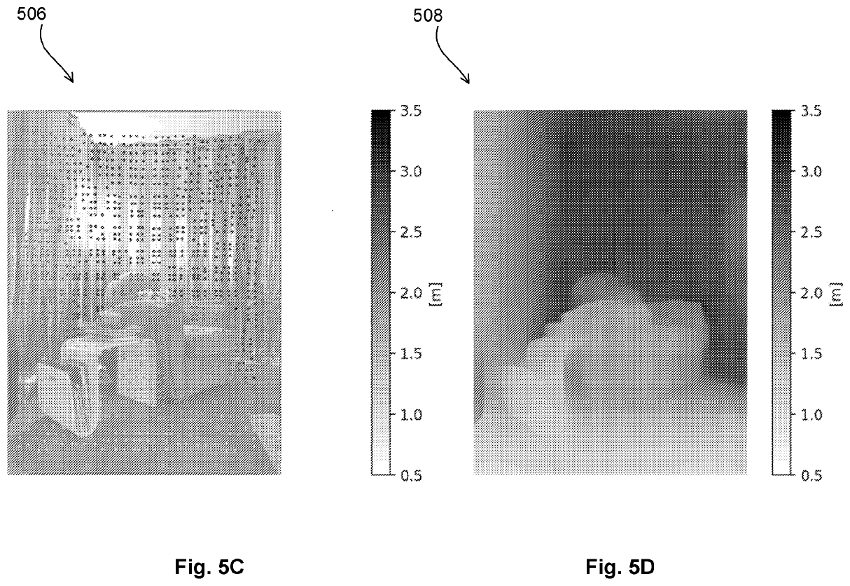

Optionally, the method 200 may comprise a step 260 of combining the depth map comprising a plurality of points with another image to form a dense depth map, as discussed further below with reference to FIGS. 5A to 5D.

The method 200 according to the present disclosure and shown schematically in FIG. 2 can be advantageous over known methods, as now discussed.

A first type of prior art method involves illumination of the field of view with radiation and then uses time of flight information to determine depth information of objects in the field of view. This prior art method outputs a depth map with each pixel of the depth map being assigned a position on a sensor of a detected reflected portion of the illumination radiation. In contrast to the method 200 according to the present disclosure, such known systems do not assign a position within the depth map for each pixel that corresponds to a position of an identified corresponding discrete radiation beams of the illumination radiation.

A second type of prior art method involves the use of a structured light source to emit a spatial light pattern (for example a plurality of stripes) into the field of view. Any distortion of a measured light pattern on a sensor relative to the emitted light pattern is attributed to reflection from objects at varying depths and this distortion is converted onto a depth map. Such systems use triangulation to determine depth information. In contrast to the method 200 according to the present disclosure, such systems do not use time of flight information.

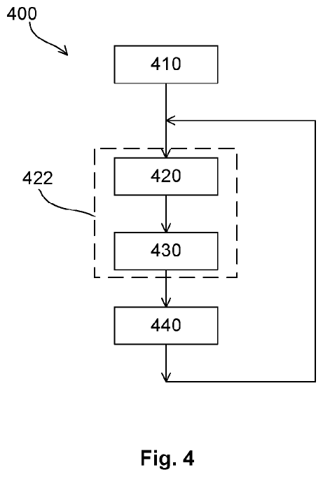

A third type of prior art method involves the use of both time of flight and structured light measurements used in combination to determine depth information. This is in contrast to the method 200 according to the present disclosure, which uses time of flight information alone to determine depth information. Compared to such known systems, the method 200 according to the present disclosure can be advantageous because it provides a system that benefits from the advantages of time of flight systems (such as high quality measurements and a large depth range) whilst reducing the amount of energy used by the system. The positions of the dots on the time-of-flight sensor 104 (which may, for example, comprise a SPAD array) vary with the distance due to the parallax effect, as now described with reference to FIGS. 3A and 3B.

FIG. 3A is a schematic representation of the trajectory 300 of a single discrete radiation beam 110 from the radiation source 102 to the field of view 112 and the trajectory 302 a reflected portion 116 of that discrete radiation beam 110. The optical center 304 of the projector 122 and a projector image plane 306 are shown in FIG. 3A. In addition, the optical center 308 of the camera 124 and a camera image plane 310 are shown in FIG. 3A. It will be appreciated that the camera image plane 310 corresponds to the plane of the sensor 104. FIG. 3B is a schematic representation of the trajectory 300 of a single discrete radiation beam 110 from the radiation source 102 to the field of view 112 and four different trajectories 302a, 302b, 302c, 302d of a reflected portion 116 of that discrete radiation beam 110. The four different trajectories 302a, 302b, 302c, 302d of a reflected portion 116 each corresponds to reflection from a different depth in the field of view 112. It can be seen from FIG. 3B that the intersection of the reflected portion 116 of a discrete radiation beam 110 with the camera image plane 310 is dependent on the depth in the field of view 112 from which the radiation is reflected.

The inventors have realised that the accuracy of the measurement of the position of a spot of a reflected portion 116 using the sensor 104 is, in general, limited by the resolution of the sensor 104. As a result, there is an error in the measured position of each dot on the sensor 104. If this measured position is used to produce a sparse or discrete depth map which is subsequently combined, or fused, with another image of the field of view (for example a photograph) to effectively interpolate between the discrete points within the field of view that are sampled using the plurality of discrete radiation beams 110 and form a dense or continuous depth map then these errors can significantly affect the combined image. For example, straight edges of an object in such a dense depth map can be curved or wavy in the combined image, which is undesirable. By producing a sparse or discrete depth map using position information for each dot from the projector 122 rather than the sensor 104, such errors can be significantly reduced.

Whilst it has previously been known to combine time-of-flight with structured light to improve the accuracy of range measurements, the method 200 according to the present disclosure uses time of flight information for range and depth measurement and information from the projected radiation light 110 to improve an x,y positioning of this measurement on the sensor 104.

The range information determined by a system using the method 200 according to the present disclosure is combined with a structured light model encoding the dot positions as a function of the distance to infer an accurate position for each distance measurement within the depth map. The structured light encoding may be estimated from calibration. As a result, the method 200 according to the present disclosure allows to estimate the dot position with a sub-pixel accuracy. Said differently, it enables to reach a resolution superior to the physical resolution of the sensor 104. For example, the method 200 according to the present disclosure may allow to estimate the dot position with an accuracy of the order of 0.1 pixels of the sensor 104. This allows to provide distance measurements with a very precise position on the sensor 104 (or any other plane it is projected onto) and may significantly improve the quality of the final depth map. Typically, the precise position of the distance measurements might have a major impact when estimating the depth close to the edges of objects.

Unless stated to the contrary, as used herein the range of an object from an optical system (for example either the camera 124 or the projector 122) is intended to mean the distance from the optical center of that optical system to the object. Furthermore, the depth of an object from an optical system (for example either the camera 124 or the projector 122) is intended to mean the projection of this distance from the optical center of that optical system to the object onto an optical axis of the system.

Note that in step 230 of the method 200 range information for an object within the field of view 112 from which each reflected portion 116 was reflected is determined based on time of flight information. Referring again to FIG. 3A, the range of the object from the projector 122 is the length of the trajectory 300 from the optical center 304 of the projector 122 to the object within the field of view 112. Similarly, the range of the object from the camera 124 is the length of the trajectory 302 from the optical center 308 of the camera 124 to the object within the field of view 112. What is measured in a direct time of flight measurement is the time taken At for the radiation to propagate along trajectory 300 and back along trajectory 302. This can be converted into the length of the radiation path by multiplying by the speed of light, cAt.

The trajectory 300 from the optical center 304 of the projector 122 to the object within the field of view 112 and the trajectory 302 from the optical center 308 of the camera 124 to the object within the field of view 112 may be considered to form two sides of a triangle. The third side of this triangle, which may be referred to as the base of the triangle, is a line from the optical center 304 of the projector 122 to the optical center 308 of the camera 124 (not shown in FIGS. 3A and 3B). The length of this base is known for a given system. Furthermore, and angle between the trajectory 300 from the optical center 304 of the projector 122 to the object within the field of view 112 and the base may be found from the intersection of the discrete radiation beam 110 with the projector image plane 306. Using geometry, the known base and angle of this triangle, along with the measured total length of the radiation path (the sum of the other two sides of the triangle) it is possible to determine either: the range of the object from the camera 124; or the range of the object from the projector 122. Similarly, using geometry, it is possible to determine the depth of the object (the height of the triangle). Since the distance between the optical center 304 of the projector 122 and the optical center 308 of the camera 124 is typically significantly smaller than both the trajectory 300 from the optical center 304 of the projector 122 to the object and the trajectory 302 from the optical center 308 of the camera 124 to the object, in some embodiments either range (from the camera 124 or from the projector 122) may be estimated as half of the length of the radiation path, cAt/2.

Note that in step 250 of method 200 each point of the depth map has a depth value corresponding to the determined range information for a detected reflected portion 116 of a discrete radiation beam. That is, the range information determined at step 230 is converted into a depth value at step 250.

The method 200 comprises a step 250 of generating a depth map comprising a plurality of points, each point having: a depth value corresponding to determined range information for a detected reflected portion 116 of a discrete radiation beam; and a position within the depth map corresponding to a position of the identified corresponding one of the plurality of discrete radiation beams 110.

Step 220 of the method 200 (detecting a reflected portion 116 of at least some of the plurality of discrete radiation beams 110) may be implemented as follows. For each of the plurality of discrete radiation beams 110 that is emitted at step 210: step 220 may involve monitoring a region of a sensor 104 that can receive reflected radiation 116 from that discrete radiation beam 110. The region of the sensor 104 may comprise a plurality of sensing elements or pixels of the sensor 104. For example, the region of the sensor 104 that is monitored may comprise a square array of sensing elements or pixels of the sensor.

If radiation is received by such a monitored region of the sensor 104 then range information for an object within the field of view 112 from which that reflected portion 116 was reflected is determined based on time of flight. Furthermore, that reflected portion 116 may be associated with, or said to correspond to, the discrete radiation beam 110 from which reflected radiation can be received by that monitored region of the sensor 104.

Step 240 of the method 200 (identifying a corresponding one of the plurality of discrete radiation beams 110 from which each reflected portion 116 originated) may be implemented as follows. If radiation is received in the monitored region of the sensor 104 for a given discrete radiation beam 110 that given discrete radiation beam 110 is identified (step 240) as the corresponding one of the plurality of discrete radiation beams 110 from which the reflected portion 116 originated.

As explained above with reference to FIG. 3B, due to the parallax effect the expected position of each dot on the time-of-flight sensor 104 corresponding to a discrete radiation beam 110 will move over time. For example, a timer may be started upon emission of a discrete radiation beam 110. The longer the time period between starting this timer and receiving a reflected portion on the sensor 104, the greater the range of the object is from which the radiation is reflected. As time passes, the expected position for receipt of the reflected radiation beam will move. In some embodiments, 220 of the method 200 (detecting a reflected portion 116 of at least some of the plurality of discrete radiation beams 110) may be implemented as follows. This detection may be divided into a plurality of detection time intervals from emission of the plurality of discrete radiation beams. In each such detection time interval, for each of the plurality of discrete radiation beams 110 a region of the sensor 104 that the reflected portion of that radiation beam 110 can be received by is monitored.

For example, each of the plurality of time intervals may correspond to a range interval. For example, the method may detect radiation from any objects with a range of 0 to 1 m in a first time interval, then detect radiation from any objects with a range of 1 to 2 m in a second time interval and so on. A region on the sensor 104 that is monitored for a given discrete radiation beam 110 may be different for each different time (or equivalently range) interval.

Step 230 of the method 200 (determining range information for an object within the field of view 112 from which each reflected portion 116 was reflected based on time of flight information) may be implemented as follows.

In some embodiments, determining range information for an object within the field of view 112 from which a reflected portion 116 was reflected based on time of flight comprises measuring a time interval from the projection of a discrete radiation beam 110 to the detection of a reflected portion 116 thereof. This may be referred to as direct time of flight measurement. A range may be determined from the time interval and a speed of the radiation (e.g. the speed of light).

Alternatively, in some other embodiments, the discrete radiation beams 110 may be modulated and determining range information for an object within the field of view from which a reflected portion 116 was reflected based on time of flight may comprise measuring a phase of such modulation. A range may be determined from the phase, a speed of the radiation (e.g. the speed of light) and the frequency of the modulation. This may be referred to as indirect time of flight measurement.

The position of the identified corresponding one of the plurality of discrete radiation beams 110 corresponds to an angle at which that corresponding discrete radiation beam 110 is emitted into the field of view. This position may be represented in the projector image plane 306. The projector plane 306 may be a focal plane of projector optics 114 that are arranged to direct the plurality of discrete radiation beams 110 into the field of view 112.

The position within the depth map corresponding to a position of each discrete radiation beam 110 may be stored in memory, for example a memory internal to or accessible by the controller 108.

In some embodiments, the position within the depth map corresponding to a position of the identified corresponding discrete radiation beam 110 may be determined from calibration data. Such calibration data may be determined once, for example, following manufacture of the apparatus 100 for carrying out the method 200 according to the present disclosure. Alternatively, calibration data may be determined periodically.

In some embodiments, the method 200 may further comprise determining calibration data from which the position within the depth map corresponding to a position of the each of the plurality of discrete radiation beams 110 may be determined.

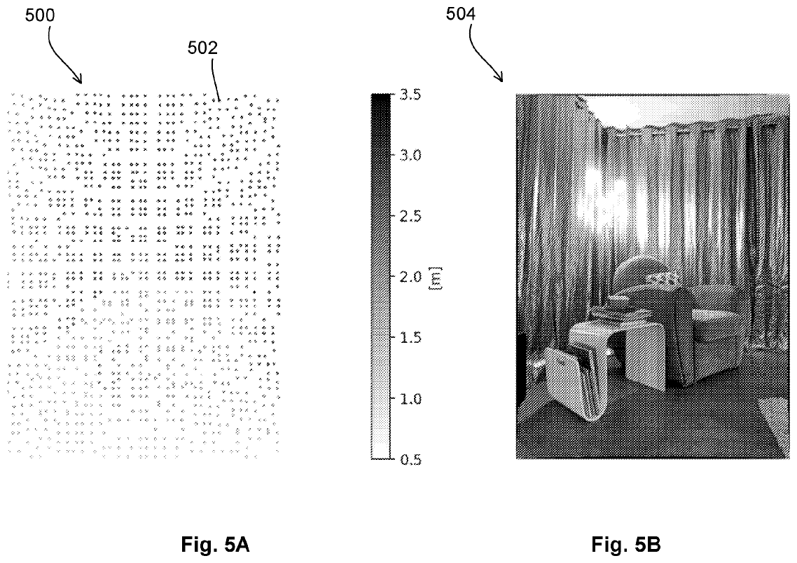

A method 400 for determining calibration data is shown schematically in FIG. 4 and is now described. First, at step 410, a flat reference surface is provided in the field of view 112. The flat reference surface may be disposed generally perpendicular to the optical axes of the projector 122 and camera 124.

Second, at step 420, the field of view 112 is illuminated with the plurality of discrete radiation beams 110. Third, at step 430, a position of reflected portion 116 of each of the plurality of discrete radiation beams 110 (reflected from the flat reference surface) is determined using the sensor 104. Steps 420 and 430 may be considered to be two parts of a measurement step 422.

Next, at step 440, the flat reference surface is moved in the field of view 112. The flat reference surface may be moved generally parallel to the optical axes of the projector 122 and camera 124 (and therefore may remain generally perpendicular to said optical axes). After step 440, steps 420 and 430 are repeated to perform another measurement step 422. Such measurement steps 422 may be made with the flat reference surface disposed at a plurality of different distances from the apparatus 100. This calibration data may allow the position within the depth map corresponding to a position of the each of the plurality of discrete radiation beams 110 to be determined.

As explained above, in some embodiments, the method 200 may comprise a step 260 of combining the depth map comprising a plurality of points with another image to form a dense depth map. This is now discussed briefly with reference to FIGS. 5A to 5D.

FIG. 5A shows a depth map 500 comprising a plurality of points 502. This depth map 500 may be referred to as a discrete depth map or a sparse depth map. Each point 502 has a depth value corresponding to determined range information for a detected reflected portion of a discrete radiation beam (indicated by the value of the points 502 on a greyscale). A position within the depth map 500 of each point 502 corresponds to a position of the identified corresponding one of the plurality of discrete radiation beams 110 (for example in a projector image plane 306).

FIG. 5B shows another image 504 of the field of view 112. The image 504 may, for example, comprise a photograph captured using a camera.

The sparse depth map 500 may be combined or fused with the other image 504 of the field of view 112, for example using known techniques, to produce a dense depth map. Such known techniques may take as input a sparse depth map and another image. The sparse depth map and other image may be fused using a machine learning model. The machine learning model may be implemented using a neural network. Such techniques may be referred to as RGB-depth map fusion or depth map densification. Such techniques will be known to the skilled person and are described, for example, in the following papers, each of which is hereby incorporated by reference: (1) Shreyas S. Shivakumar, Ty Nguyen, Ian D. Miller, Steven W. Chen, Vijay Kumar and Camillo J. Taylor, “DFuseNet: Deep Fusion of RGB and Sparse Depth Information for Image Guided Dense Depth Completion”, arXiv preprint arXiv: 1902.00761v2 [cs.CV], 10-7-2019; and (2) Z. Chen, V. Badrinarayanan, G. Drozdov, and A. Rabinovich, “Estimating Depth from RGB and Sparse Sensing”, arXiv preprint arXiv: 1804.02771, 2018. In order to combine the sparse depth map 500 with the other image 504, the sparse depth map 500 and the other image 504 are aligned to produce a combination 506 of two overlaid images, as shown in FIG. 5C. Note that in order to implement such alignment the depth map 500 may be projected onto an image plane of the other image 504. It will be appreciated that this projection is merely a geometric transformation from the projector image plane 306 to an image plane of the other image 504.

FIG. 5D shows a dense depth map 508 produced from the combination of the sparse depth map 500 with the other image 504 of the field of view 112.

This effectively interpolates between the discrete points within the field of view 112 that are sampled using the plurality of discrete radiation beams 110 to from the sparse depth map 500. Using a position for each point 502 of the discrete depth map of the corresponding discrete radiation beam 110 that was projected onto the field of view 112 significantly reduces the errors in this interpolation.

### LIST OF REFERENCE NUMERALS

100 apparatus for generating a depth map of a field of view
102 radiation source
104 sensor
106 focusing optics
108 controller
110 a plurality of discrete radiation beams
112 field of view
114 projection optics
116 reflected portions
118 control signal
120 signals
122 projector
124 camera
200 method for generating a depth map for a field of view
210 step of illuminating the field of view
220 step of detecting reflected radiation
230 step of determining range information
240 step of identifying corresponding discrete radiation beams
250 step of generating a depth map
260 step of combining the depth map with another image to form a dense depth map 300 trajectory of a single discrete radiation beam
302 trajectory of a reflected portion of that discrete radiation beam 302a first trajectory of a reflected portion of that discrete radiation beam 302b second trajectory of a reflected portion of that discrete radiation beam 302c third trajectory of a reflected portion of that discrete radiation beam 302d fourth trajectory of a reflected portion of that discrete radiation beam
304 optical center of the projector
306 projector image plane
308 optical center of the camera
310 camera image plane
400 method for determining calibration data
410 step of providing a flat reference surface
420 step of illuminating the field of view
430 step of determining a position of reflected radiation beams
440 step of moving the flat reference surface
500 depth map comprising a plurality of points
502 point in depth map
504 another image of the field of view
506 a combination of two overlaid images
508 dense depth map

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

What is claimed is:

1. A method for generating a depth map for a field of view, the method comprising:
illuminating the field of view with a plurality of discrete radiation beams;
detecting a reflected portion of at least some of the plurality of discrete radiation beams;
determining range information for an object within the field of view from which each reflected portion was reflected based on time of flight;
identifying a corresponding one of the plurality of discrete radiation beams from which each reflected portion originated; and
generating a depth map comprising a plurality of points, each point having:
a depth value corresponding to a determined range information for a detected reflected portion of a discrete radiation beam; and
a position within the depth map corresponding to a position of the identified corresponding one of the plurality of discrete radiation beams.

2. The method of claim 1 comprising: for each of the plurality of discrete radiation beams: monitoring a region of a sensor that can receive reflected radiation from that discrete radiation beam.

3. The method of claim 2 wherein if radiation is received in the monitored region of the sensor for a given discrete radiation beam that given discrete radiation beam is identified as the corresponding one of the plurality of discrete radiation beams from which a reflected portion originated.

4. The method of claim 1 comprising: for a plurality of time intervals from emission of the plurality of discrete radiation beams: for each of the plurality of discrete radiation beams: monitoring a region of a sensor that the reflected portion of that discrete radiation beam can be received by.

5. The method of claim 1 wherein determining range information for an object within the field of view from which a reflected portion was reflected based on time of flight comprises measuring a time interval from the projection of a discrete radiation beam to the detection of a reflected portion thereof.

6. The method of claim 1 wherein the position of the identified corresponding one of the plurality of discrete radiation beams corresponds to an angle at which that corresponding discrete radiation beam is emitted into the field of view.

7. The method of claim 1 wherein the position within the depth map corresponding to a position of the identified corresponding discrete radiation beam is determined from calibration data.

8. The method of claim 1 further comprising determining calibration data from which the position within the depth map corresponding to a position of the each of the plurality of discrete radiation beams may be determined.

9. The method of claim 8 wherein determining calibration data comprises: providing a flat reference surface in the field of view; illuminating the field of view with the plurality of discrete radiation beams; and detecting a position of reflected portion of each of the plurality of discrete radiation beams.

10. The method of claim 1 further comprising combining the depth map comprising a plurality of points with another image to form a dense depth map.

11. An apparatus for generating a depth map for a field of view, the apparatus operable to implement a method comprising:
illuminating the field of view with a plurality of discrete radiation beams;
detecting a reflected portion of at least some of the plurality of discrete radiation beams;
determining range information for an object within the field of view from which each reflected portion was reflected based on time of flight;
identifying a corresponding one of the plurality of discrete radiation beams from which each reflected portion originated; and
generating a depth map comprising a plurality of points, each point having:
a depth value corresponding to a determined range information for a detected reflected portion of a discrete radiation beam; and
a position within the depth map corresponding to a position of the identified corresponding one of the plurality of discrete radiation beams.

12. The apparatus of claim 11, wherein the apparatus comprises:
a radiation source that is operable to emit a plurality of discrete radiation beams;
a sensor operable to receive and detect a reflected portion of at least some of the plurality of discrete radiation beams; and
a controller operable to control the radiation source and the sensor and further operable to implement any steps of the method.

13. The apparatus of 12 further comprising focusing optics arranged to form an image of a field of view in a plane of the sensor.

14. The apparatus of claim 12 wherein the sensor comprises an array of sensing elements.

15. The apparatus of claim 14 wherein each sensing element in the two dimensional array of sensing elements comprises a single-photon avalanche diode.
